(19) United States
(12) Patent Application Publication
(10) Pub. No.: US 2009/0009152 A1
(43) Pub. Date: Jan. 8, 2009

(54) BIAS SUPPLY, START-UP CIRCUIT, AND START-UP METHOD FOR BIAS CIRCUIT

(75) Inventors: Leaf Chen, Taipei City (TW); Chih-Shun Lee, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: BEYOND INNOVATION TECHNOLOGY CO., LTD., Taipei City (TW)

(21) Appl. No.: 12/055,304

(22) Filed: Mar. 25, 2008

(30) Foreign Application Priority Data
Jul. 2, 2007 (TW) 96124006

(51) Int. Cl. G05F 3/16

(52) U.S. Cl. 323/315

(57) ABSTRACT

A bias supply, a start-up circuit, and a start-up method for a bias circuit are provided. The bias supply includes the bias circuit, a first switch, a second switch, and a charge storage unit. The first switch is coupled between a first voltage and a node. The first switch determines whether or not to be turned on according to a feedback voltage from the bias circuit. The charge storage unit is coupled between the node and a second voltage. The second switch determines whether or not to output a start-up voltage to the bias circuit according to the voltage of the node. In other words, the present invention utilizes charge/discharge properties of the charge storage unit and the feedback voltage from the bias circuit for controlling whether the second switch outputs a start-up voltage to the bias circuit or not. Therefore, the power consumption of the start-up circuit is decreased.

### CROSS-REFERENCE TO RELATED APPLICATION

This application claims the priority benefit of Taiwan application serial no. 96124006, filed on Jul. 2, 2007. The entirety of the above-mentioned patent application is hereby incorporated by reference herein and made a part of this specification.

### BACKGROUND OF THE INVENTION

1. Field of the Invention

The present invention generally relates to a bias supply, in particular, to a start-up technology of the bias supply.

2. Description of Related Art

In analog circuits, usually, current mirrors are used as bias circuits. The bias circuits need start-up circuits to work normally.

FIG. 1 shows a circuit diagram of a conventional bias supply. Referring to FIG. 1, a bias supply 10 may be divided into two parts, namely a bias circuit 20 and a start-up circuit 30. The bias circuit 20 includes current mirrors 40, 41, and a resistor 130. The current mirror 40 is composed of N-channel metal oxide semiconductor (MOS) transistors 110, 111. A drain and a gate of the transistor 110 are coupled to each other. Channel width/length ratios of the transistors 110, 111 are different. The resistor 130 is used to provide a voltage difference, so as to enable the current mirror 40 to produce a current. The current mirror 41 is composed of P-channel MOS transistors 120, 121. A drain and a gate of the transistor 121 are coupled to each other. The start-up circuit 30 is composed of a P-channel MOS transistor 130, and N-channel MOS transistors 131, 132, 133. The transistors 130, 131, 132, 133 are equivalent to a diode, respectively.

The bias circuit 20 has two stable point states, namely a zero stable state and a saturation stable state. At the beginning of providing a voltage Vdd to the bias circuit 20, the bias circuit 20 may be in the zero stable state, a node B may maintain at a voltage of a relatively low potential, and a node C may maintain at a voltage of a relatively high potential. Until the node B receives a start-up voltage of a relatively high potential or the node C receives a voltage of a relatively low potential, the bias circuit 20 transits from the zero stable state to the saturation stable state, and provides a stable bias to other circuits for use.

In order to provide the start-up voltage to the bias circuit 20, the start-up circuit 30 utilizes the transistors 130, 131, 132 to provide a bias VB to the node A, such that the transistor 133 is turned on, thereby providing a start-up voltage of a relatively high potential to the node B. When the bias circuit 20 transits to the saturation stable state, the bias of the node B may be higher than that of the node A, such that the transistor 133 equivalent to a diode is turned off so as to prevent the bias circuit 20 from being interfered by the start-up circuit 30. It should be noted that the transistors 130, 131, 132 of the start-up circuit 30 are normally turned on. In other words, even if the bias circuit 20 has been started up, the transistors 130, 131, 132 still maintain the turn-on state. Therefore, the power consumption of the start-up circuit 30 is very large.

FIG. 2 shows a circuit diagram of another conventional bias supply. Referring to FIG. 2, a bias supply 11 is divided into two parts, namely a bias circuit 20 and a start-up circuit 31 respectively. The bias circuit 20 can refer to the above description. It should be noted that the start-up circuit 31 is composed of an inverter 50 and an N-channel MOS transistor 212. The N-channel MOS transistor 212 may be regarded as a switch. The inverter 50 is composed of a P-channel MOS transistor 210 and an N-channel MOS transistor 211.

When the bias circuit 20 is in the zero stable state, the node B may maintain a voltage of a relatively low potential. The start-up circuit 31 inputs the bias of the node B to the inverter 50 using a feedback technology, so the inverter 50 outputs a voltage of a relatively high potential to the node A, so as to turn on transistor 212. When the transistor 212 is turned on, the voltage of the node C drops to a voltage of a relatively low potential, such that the bias circuit 20 transits from the zero stable state to the saturation stable state.

As described above, when the bias circuit 20 is in the saturation stable state, the node B may maintain a voltage of a relatively high potential. The start-up circuit 31 utilizes the inverter 50 to maintain the voltage of the node A to be a voltage of a relatively low potential, and thus the transistor 212 stays at a turned-off state. In this way, the bias circuit 20 will not be interfered by the start-up circuit 31. It is worthy of mention that when the bias circuit 20 is in the saturation stable state, the voltage of a relatively high potential of the node B is proximately at 4 V to 8 V. Assuming that the voltage Vdd is much higher than the voltage of the node B, e.g., the voltage Vdd is 20 V, the inverter 50 cannot turn off the transistor 212. Therefore, not only the start-up circuit 31 may suffer from a large amount of leakage current, but also the bias circuit 20 cannot work normally with the interference from the start-up circuit 31. In other words, the start-up circuit 31 disclosed in the conventional art may be used only when the voltage Vdd is not high.

### SUMMARY OF THE INVENTION

Accordingly, the present invention is directed to a bias supply, so as to ensure that the bias circuit may be wakened up and work normally.

The present invention is directed to a start-up circuit, thereby decreasing the leakage current.

The present invention is directed to a start-up method for a bias circuit, in which whether or not to provide a start-up voltage to the bias circuit is determined according to charge/discharge properties of the charge storage unit and a feedback voltage from the bias circuit, thereby decreasing the power consumption.

The present invention provides a bias supply, which includes a bias circuit, a first switch, a second switch, and a charge storage unit. The bias circuit is coupled between a first voltage and a second voltage, and outputs a feedback voltage. The first switch is coupled between the first voltage and a node, and determines whether or not to be turned on according to the feedback voltage. The charge storage unit is coupled between the node and the second voltage. The second switch determines whether or not to output a start-up voltage to the bias circuit according to the voltage of the node.

In an embodiment of the present invention, the bias supply further includes a buffer, which is coupled between the node and the second switch for providing the voltage of the node to the second switch. In another embodiment, the bias supply further includes an inverter coupled between the node and the second switch for providing a reverse potential of the node to the second switch. In yet another embodiment, the inverter includes a first transistor and a second transistor. A first terminal, a second terminal, and a gate terminal of the first transistor are respectively coupled to the first voltage, the second switch, and the node. A first terminal, a second terminal, and a gate terminal of the second transistor are respectively coupled to the second switch, the second voltage, and the node. In still another embodiment, the first transistor is a P-channel MOS transistor, and the second transistor is an N-channel MOS transistor.

In an embodiment of the present invention, the bias circuit includes a first current mirror and a second current mirror. The first current mirror is coupled to a first voltage, and includes a first transistor and a second transistor. The first transistor has a first terminal coupled to a first voltage, a second terminal, and a gate terminal coupled to the second terminal. The second transistor has a first terminal and a gate terminal respectively coupled to the first terminal and the gate terminal of the first transistor. The second current mirror is coupled between the first current mirror and a second voltage, and includes a third transistor and a fourth transistor. The third transistor has a first terminal and a second terminal respectively coupled to the second terminal of the first transistor and the second voltage. The fourth transistor has a first terminal and a gate terminal coupled to the second terminal of the second transistor, and a second terminal coupled to the second voltage. Channel width/length ratios of the third transistor and the fourth transistor are different. The bias circuit is used to provide a stable bias.

As described above, in another embodiment, when the first terminal of the third transistor receives a start-up voltage, the bias circuit transits from the zero stable state to the saturation stable state, and provides a stable bias. In yet another embodiment, the start-up voltage is the second voltage. In still another embodiment, when the first terminal of the fourth transistor receives the start-up voltage, the bias circuit transits from the zero stable state to the saturation stable state, and provides a stable bias. In a further embodiment, the start-up voltage is the first voltage. In another embodiment, the feedback voltage is provided by the first terminal of the third transistor or the first terminal of the fourth transistor. In yet another embodiment, the first and second transistors are P-channel MOS transistors, and the third and fourth transistors are N-channel MOS transistors.

In an embodiment of the present invention, the first switch includes a first transistor. The first transistor has a first terminal and a second terminal respectively coupled to the first voltage and the node, and a gate terminal receiving the feedback voltage, so as to determine whether or not to conduct the first terminal and the second terminal of the first transistor. In another embodiment, the charge storage unit includes a capacitor coupled between the node and the second voltage. When the capacitor is in a charging state, a start-up voltage is output to the bias circuit. When the capacitor is in a saturation state, the outputting of the start-up voltage to the bias circuit is stopped. In yet another embodiment, the charge storage unit includes a first transistor. The first transistor has a first terminal and a second terminal coupled to the second voltage, and a gate terminal coupled to the node. In still another embodiment, the second switch includes a first transistor. A first terminal, a second terminal, and a gate terminal of the first transistor are respectively coupled to the bias circuit, a third voltage, and the node. The first transistor determines whether or not to conduct the first terminal and the second terminal of the first transistor according to the voltage of the node.

From another point of view, the present invention provides a start-up circuit for starting up the bias circuit. The start-up circuit includes a first switch, a second switch, and a charge storage unit. The first switch has a first terminal and a second terminal respectively coupled to a first voltage and a node, and receives a feedback voltage of the bias circuit, so as to determine whether or not to be turned on. A first terminal and a second terminal of the charge storage unit are respectively coupled to the node and a second voltage. The second switch determines whether or not to provide a start-up voltage to the bias circuit according to the voltage of the node.

From yet another point of view, the present invention provides a start-up method for a bias circuit. In the start-up method, a charge storage unit is charged to change the voltage of a node, and whether or not to output a start-up voltage to the bias circuit is determined according to the voltage of the node. In addition, a feedback voltage is received, thereby changing the voltage of the node.

In an embodiment, when the charge storage unit is in the charging state, the node is at a first potential, thereby turning on the first switch to output a start-up voltage to the bias circuit. When the charge storage unit is in a saturation state, the node is at a second potential, thereby turning off the first switch to stop outputting the start-up voltage to the bias circuit. In another embodiment, the feedback voltage changes with the state of the bias circuit. In yet another embodiment, the step of receiving the feedback voltage to change the voltage of the node includes determining whether or not to turn on the second switch according to the feedback voltage. In a further embodiment, when the bias circuit transits from the zero stable state to the saturation stable state, the feedback voltage makes the potential of the node to transit, thereby cutting off the first voltage.

The present invention couples the first switch between the first voltage and the node, and determines whether or not to turn on the first switch according to the feedback voltage from the bias circuit. Furthermore, the charge storage unit is coupled between the node and the second voltage. Also, the second switch determines whether or not to output the start-up voltage to the bias circuit according to the voltage of the node. In other words, the present invention utilizes the charge/discharge properties of the charge storage unit and the feedback voltage from the bias circuit for controlling whether the second switch outputs the start-up voltage to the bias circuit or not. Therefore, the power consumption of the start-up circuit is decreased.

In order to make the features and advantages of the present invention more clear and understandable, the following embodiments are illustrated in detail with reference to the appended drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a circuit diagram of a conventional bias supply.

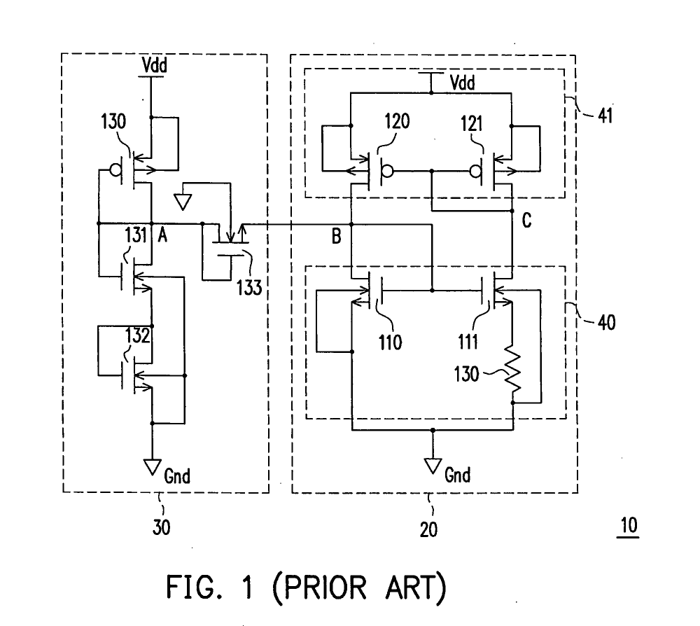

FIG. 2 shows a circuit diagram of another conventional bias supply.

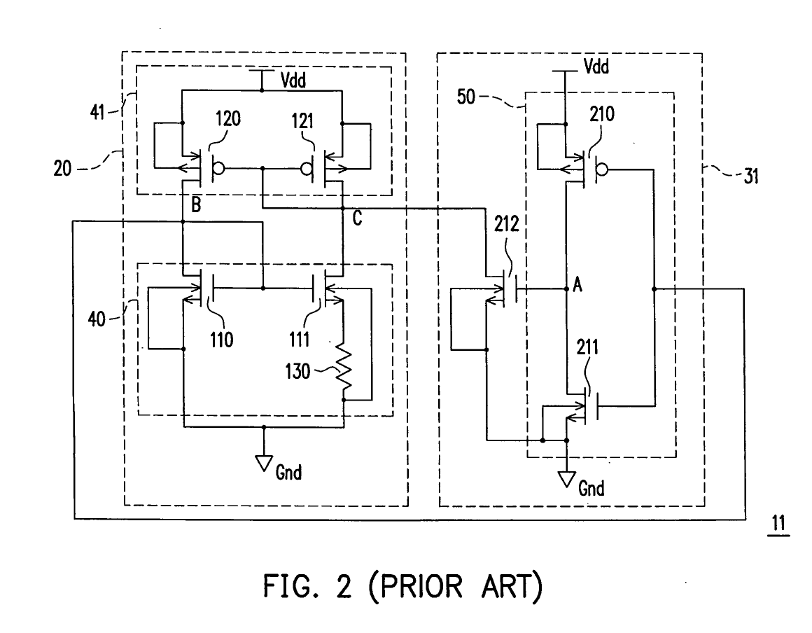

FIG. 3A is a circuit diagram of a bias supply according to a first embodiment of the present invention.

FIG. 3B is a circuit diagram of a bias supply according to a second embodiment of the present invention.

FIG. 4 is a flow chart of a start-up method for a bias circuit according to a first embodiment of the present invention.

FIG. 5A is a circuit diagram of a bias supply according to a third embodiment of the present invention.

FIG. 5B is a circuit diagram of a bias supply according to a fourth embodiment of the present invention.

FIG. 6A is a circuit diagram of a bias supply according to a fifth embodiment of the present invention.

FIG. 6B is a circuit diagram of a bias supply according to a sixth embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

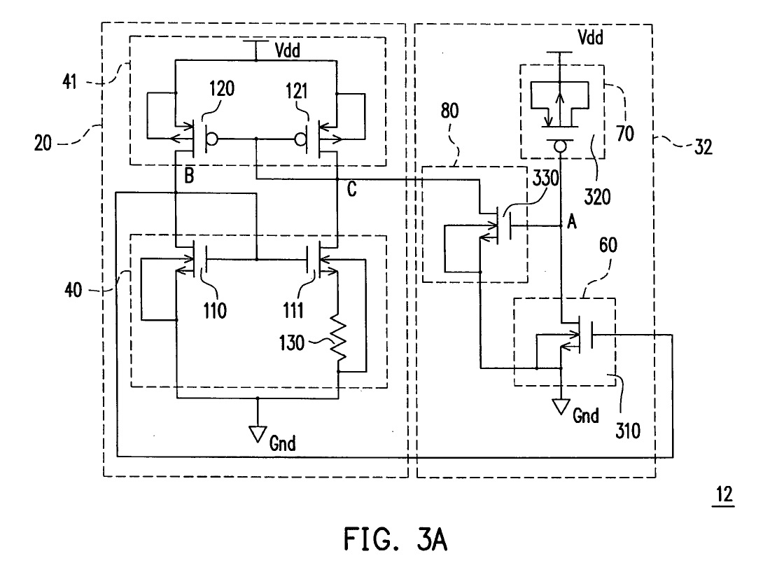

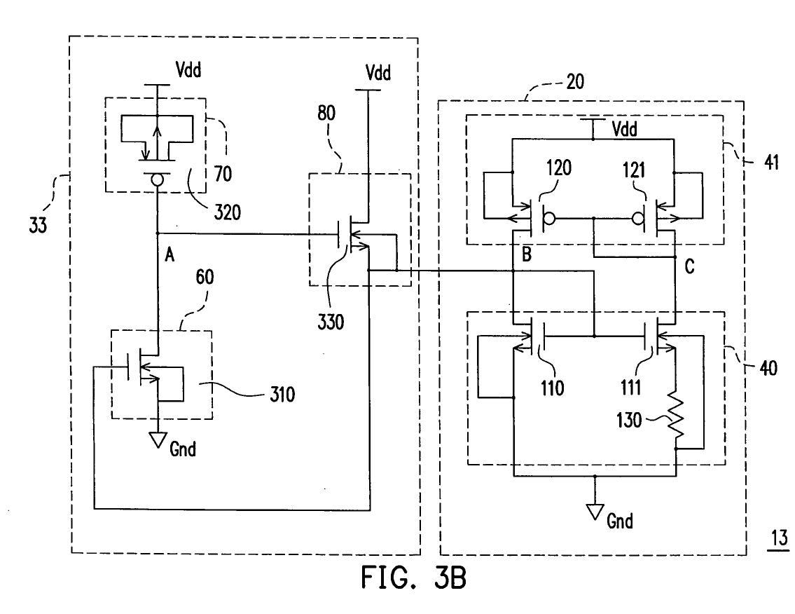

FIG. 3A is a circuit diagram of a bias supply according to a first embodiment of the present invention. Referring to FIG. 3A, a bias supply 12 includes a bias circuit 20 and a start-up circuit 32. The bias circuit 20 includes current mirrors 40, 41. The current mirror 40, for example, includes N-channel MOS transistors 110, 111 and a resistor 130. A drain and a gate of the transistor 110 are coupled to each other, and the channel width/length ratios of the transistors 110, 111 are different. The resistor 130 is used to provide a voltage difference to enable the current mirror 40 to produce a current. The current mirror 41, for example, is composed of P-channel MOS transistors 120, 121. A drain and a gate of the transistor 121 are coupled to each other.

Generally speaking, the bias circuit 20 has two stable point states, namely a zero stable state and a saturation stable state. At beginning of providing a voltage Vdd to the bias circuit 20, the bias circuit 20 may be in the zero stable state, a node B may maintain a voltage of a relatively low potential, and a node C may maintain a voltage of a relatively high potential. Until the node B receives a start-up voltage (e.g., a voltage Vdd) of a relatively high potential or the node C receives a voltage (e.g., ground) of a relatively low potential, the bias circuit 20 may transit from the zero stable state to the saturation stable state, and provide a stable bias to other circuits for use. Those skilled in the art should know that the bias circuit 20 may have different forms according to the requirements of the designers. For example, the bias circuit 20 may also be composed of three current mirrors cascaded in series. In other words, the present invention is not limited to the form of bias circuit.

The start-up circuit 32 includes a switch 60, a charge storage unit 70, and a switch 80. In the embodiment, the switch 60 is implemented by, for example, an N-channel MOS transistor 310. But in other embodiments, the switch 60 may also be a P-channel MOS transistor or an electronic switch of another form. A gate terminal, a source terminal, and a drain terminal of the transistor 310 are respectively coupled to the node B, the ground, and the node A. The charge storage unit 70, for example, includes a P-channel MOS transistor 320. A gate terminal of the transistor 320 is coupled to the node A, and a source and a drain of the transistor 320 are coupled to a voltage Vdd. Therefore, the transistor 320 may be equivalent to a capacitor. In the embodiment, the advantage for employing the transistor 320 to implement the charge storage unit 70 is that, the volume of the transistor 320 is quite small, and the fabricating process is cheap. But in other embodiments, the charge storage unit 70 may also be implemented by a capacitor. The switch 80 is, for example, but not limited to, an N-channel MOS transistor 330. In other embodiments, the switch 80 may be implemented by an electronic switch of any form. A gate terminal, a source terminal, and a drain terminal of the transistor 330 are respectively coupled to the node A, the ground, and the node B. The transistor 330 may determine whether or not to conduct the source terminal and the drain terminal of the transistor 330 according to the voltage of the node A. The operation manner of the start-up circuit 32 will be described in further detail as follows.

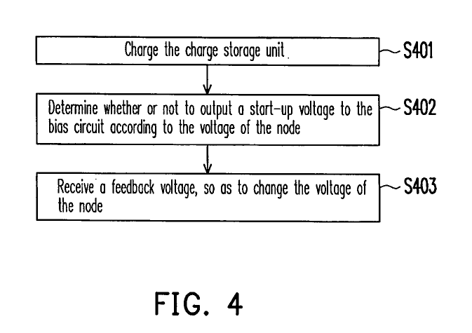

FIG. 4 is a flow chart of a start-up method for a bias circuit according to a first embodiment of the present invention. Referring to FIGS. 3A and 4 together, in a step S401, a voltage Vdd (e.g., 20 V) is provided to the start-up circuit 32 and the bias circuit 20. At this time, the transistor 310 may be in a semi-conducted state, e.g., operates in a linear region, and thus the transistor 320 may be charged. Further, the transistor 320 may also be charged by utilizing a ground path provided by a parasitic capacitance of the transistor 330. In the embodiment, the voltage Vdd is, for example, 20 V, but in other embodiments, the voltage Vdd may also be 3 V to 20 V according to the requirements. When the transistor 320 is in the charging state, the voltage of the node A is reduced from the voltage Vdd to around 0 V. That is to say, at the beginning of charging the transistor 320, the voltage of the node A is quite high. Therefore, the transistor 330 is in a turn-on state, thereby outputting a start-up voltage of a relatively low potential to an endpoint C of the bias circuit 20 (step S402). In this manner, the start-up circuit 32 may waken up the bias circuit 20, such that the bias circuit 20 may transit from the zero stable state to the saturation stable state, so as to provide a stable bias to other circuits for use.

As described above, when the bias circuit 20 transits from the zero stable state to the saturation stable state, the voltage of the node B may change from the voltage of a relatively low potential to a voltage of a relatively high potential, and the voltage of the node C may change from the voltage of a relatively high potential to a voltage of a relatively low potential. In the embodiment, a voltage feedback from the node B is used to control whether or not to turn on the transistor 310. In other embodiments, the voltage of the node C may also be used to realize a feedback control manner. In other words, the transistor 310 may receive the voltage of a relatively high potential of the node B (step S403), so as to turn on the transistor 310, and decrease the voltage of the node A, such that the transistor 330 is turned off. From another point of view, when the transistor 320 continues to be charged, the voltage of the endpoint A may also be reduced, so as to turn off the transistor 330. Therefore, the application level of the start-up circuit 32 will not be limited to the range of the voltage Vdd. Based on the above two reasons, the transistor 330 may be ensured to be turned off. When the transistor 330 is turned off, the start-up circuit 32 may stop outputting the start-up voltage to the bias circuit 20. In this manner, the start-up circuit 32 will not interfere with the operation of the bias circuit 20.

Furthermore, since the gate terminal and the source-drain of the transistor 320 may be regarded as an open circuit when the transistor 320 is charged to a saturation state, almost no current will flow from the gate terminal of the transistor 320 to the source-drain of the transistor 320, thereby decreasing the leakage current of the start-up circuit 32, and further decreasing the power consumption of the bias supply 12. Further, it takes a period of time to charge the transistor 320. In other words, in this period of time, the start-up circuit 32 may continues providing the start-up voltage to the bias circuit 20 to ensure that the bias circuit 20 to enter the saturation stable state. More than that, the embodiment uses only three transistors to achieve the start-up circuit 32. Compared with the conventional technology, the circuit cost is greatly decreased in this embodiment.

It is worthy of mention that although the above embodiment has described a possible configuration to the bias supply, the start-up circuit, and the start-up method for a bias circuit, those of ordinary skill in the art should know that, each manufacturer has a different design for the bias supply, the start-up circuit, and the start-up method for a bias circuit. Therefore, the application of the present invention is not limited to such a possible configuration. In other words, it conforms to the spirit of the present invention, as long as the charge/discharge properties of the capacitor and the feedback voltage from the bias circuit are used for controlling the start-up of the bias circuit. Several embodiments are further illustrated below in order to enable those of ordinary skill in the art to further understand the spirit of the present invention and implement the present invention.

Those skilled in the art may also properly change the architecture of the bias supply, thereby wakening up the bias circuit from the node B. For example, FIG. 3B is a circuit diagram of a bias supply according to a second embodiment of the present invention. Referring to FIG. 3B, like elements with like reference numerals of that of the aforementioned embodiments in a bias supply 13 can refer to the aforementioned implementations. It should be noted that in the embodiment, a drain and a source of the transistor 330 are respectively coupled to the voltage Vdd and the node B. At the beginning of charging the transistor 320, the voltage of the node A is a voltage of a relatively high potential, so as to turn on the transistor 330. The node B receives a voltage of a relatively high potential. The bias circuit 20 is wakened up, and maintains the saturation stable state.

When the bias circuit 20 transits from the zero stable state to the saturation stable state, the voltage of the node B may transit from the voltage of a relatively low potential to a voltage of a relatively high potential, so as to turn on the transistor 310, and make the voltage of the node A to be a voltage of a relatively low potential. From another point of view, when the transistor 320 is charged to the saturation state, the voltage of the node A may become a voltage of a relatively low potential. Based on the above double effects, the transistor 330 may be ensured to be turned off. Therefore, the bias circuit 20 will not be interfered by the start-up circuit 33. In this manner, the embodiment may also achieve a function similar to the above embodiments.

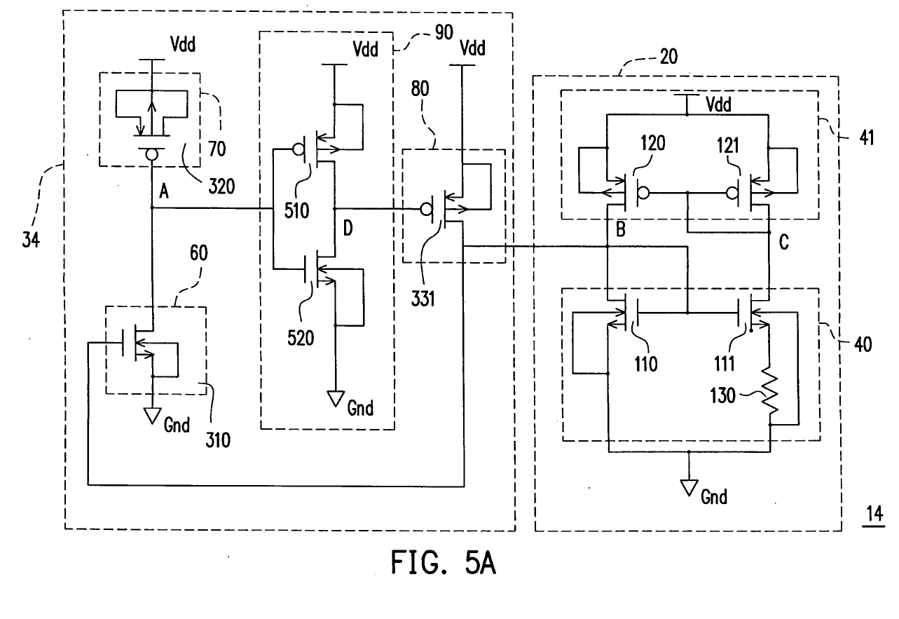

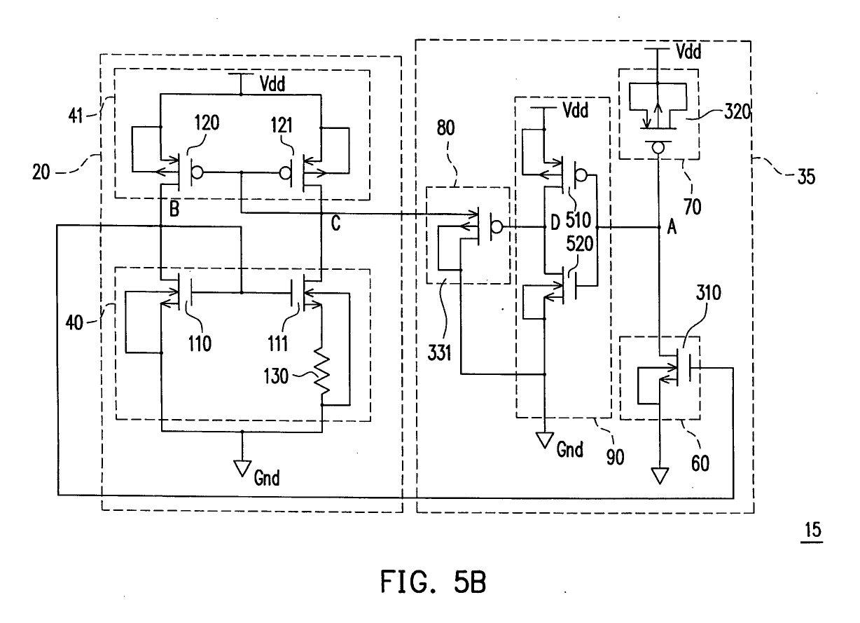

Those skilled in the art may add an inverter between the node A and the switch, and properly adjust the circuit architecture, thereby alleviating the voltage floating. For example, FIG. 5A is a circuit diagram of a bias supply according to a third embodiment of the present invention. Referring to FIG. 5A, like elements with like reference numerals of that of the aforementioned embodiments in a bias supply 14 can refer to the aforementioned implementations. An inverter 90 is added between the node A and the switch 80 in the embodiment. The inverter 90 is, for example, but not limited to, a P-channel MOS transistor 510 and an N-channel MOS transistor 520. The switch 80 is implemented by a P-channel MOS transistor 331. The operation of the bias supply 14 is described in detail as follows.

First, a voltage Vdd (e.g., 20 V) is provided to the start-up circuit 34 and the bias circuit 20. At this time, the transistor 310 may be in the semi-conducted state, e.g., operates in the linear region, and thus the transistor 320 may be charged. Further, the transistor 320 may also be charged through the ground path provided by the parasitic capacitance of the transistor 510. When the transistor 320 is in a charging state, the voltage of the node A may be reduced from the voltage Vdd to around 0V. That is to say, at the beginning of charging the transistor 320, the voltage of the node A is a voltage of a relatively high potential. Then, by the inverter 90, the node D may maintain a voltage of a relatively low potential. Therefore, the transistor 331 may be in the turn-on state, thereby outputting a start-up voltage of a relatively high potential to an endpoint B of the bias circuit 20. In this manner, the start-up circuit 34 may waken up the bias circuit 20, such that the bias circuit 20 may transit from the zero stable state to the saturation stable state, thereby providing a stable bias to other circuits-for use.

As described above, when the bias circuit 20 is in the saturation stable state, the transistor 310 may receive the voltage of a relatively high potential of the node B, so as to turn on the transistor 310 and reduce the voltage of the node A, such that the transistor 331 is turned off. From another point of view, when the transistor 320 continues to be charged, the voltage of the endpoint A may also be reduced, so as to turn off the transistor 331. Based on the above two reasons, the transistor 331 may be ensured to be turned off. When the transistor 331 is turned off, the start-up circuit 34 may stop outputting the start-up voltage to the bias circuit 20. In this manner, the start-up circuit 34 may not interfere with the operation of the bias circuit 20.

Furthermore, as the gate terminal and the source-drain of the transistor 320 may be regarded as an open circuit when the transistor 320 is charged to the saturation state, almost no current will flow from the gate terminal of the transistor 320 to the source-drain of the transistor 320, thereby decreasing the power consumption of the bias supply 14. More than that, the embodiment further alleviates the voltage floating of the node A through the inverter 90. That is to say, the inverter 90 may make the node D to maintain at a stable voltage level, thereby controlling whether or not to turn on the switch 80.

Those of ordinary skill in the art may certainly change the charging direction of the charge storage unit 70. For example, FIG. 5B is a circuit diagram of a bias supply according to a fourth embodiment of the present invention. Referring to FIG. 5B, like elements with like reference numerals of that of the aforementioned embodiments in a bias supply 15 can refer to the aforementioned implementations. In the embodiment, a gate terminal, a source terminal, and a drain terminal of the transistor 310 are respectively coupled to the node B, the ground, and the node A. At the beginning of providing the voltage Vdd to the bias supply 15, the transistor 310 is in the semi-conducted state, e.g., operates in a linear region, and thus the transistor 320 may be charged. Further, the transistor 320 may also be charged through the ground path provided by the parasitic capacitance of the transistor 520. At the beginning of charging the transistor 320, the voltage of the node A is a voltage of a relatively high potential. Through a transition of the inverter 90, the node D is at a voltage of a relatively low potential. Then, the transistor 331 is turned on, and the node C receives a voltage of a relatively low potential. The bias circuit 20 is wakened up, and maintains a saturation stable state.

When the bias circuit 20 is in the saturation stable state, the transistor 310 may receive the voltage of a relatively high potential of the node B, so as to turn on the transistor 310, and reduce the voltage of the node A. Further, when the transistor 320 is charged to the saturation state, the voltage of the node A may become a voltage of a relatively low potential. Through the transition of the inverter 90, the node D is at a voltage of a relatively high potential. Then, the transistor 331 is turned off, and the bias circuit 20 may not be interfered by the start-up circuit 35. In this manner, a function similar to the above embodiment may be achieved.

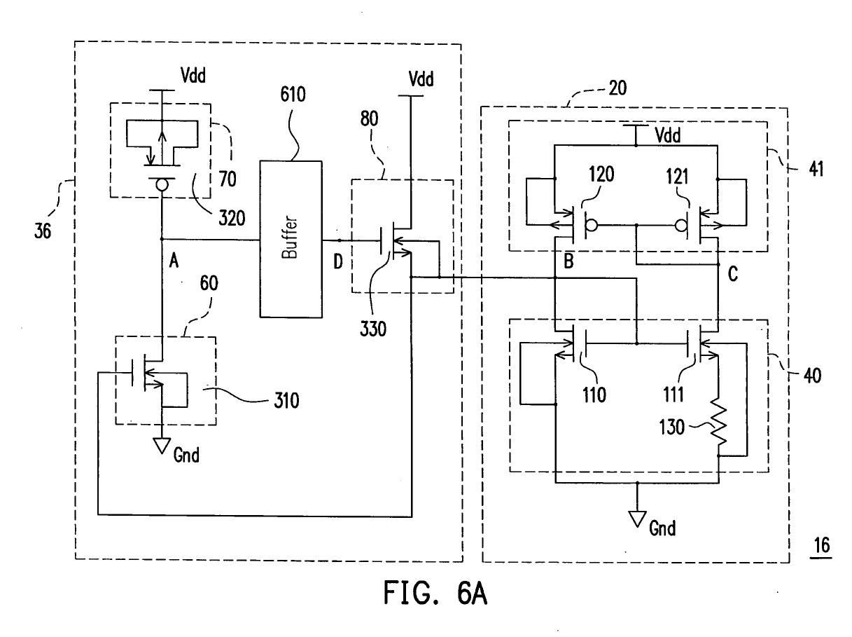

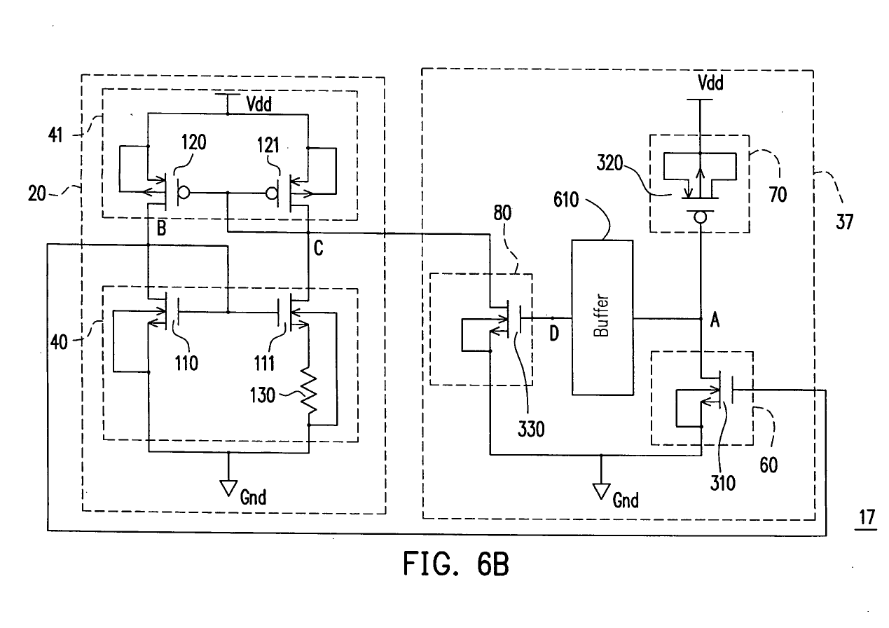

Those skilled in the art may also add a buffer between the node A and the switch, and adjust the circuit architecture properly, thereby further ensuring that the bias circuit may be wakened up. For example, FIG. 6A is a circuit diagram of a bias supply according to a fifth embodiment of the present invention. Referring to FIG. 6A, like elements with like reference numerals of that of the aforementioned embodiments in a bias supply 16 can refer to the aforementioned implementations. The embodiment adds a buffer 610 between the node A and the switch 80. The buffer 610 may, for example, but not limited to, be composed two inverters connected in series. At the beginning of charging the transistor 320, the voltage of the node A is a voltage of a relatively high potential. Then, the buffer 610 provides a voltage of a relatively high potential to the node D. Through turning on the transistor 330, the node B receives a voltage of a relatively high potential. The bias circuit 20 is wakened up, and maintains the saturation stable state.

When the bias circuit 20 is at the saturation stable state, the transistor 310 may receive the voltage of a relatively high potential of the node B, so as to turn on the transistor 310, and reduce the voltage of the node A. Further, when the transistor 320 is charged to the saturation state, the voltage of the node A may become the voltage of a relatively low potential. The buffer 610 provides the voltage of a relatively low potential to the node D. Then, the transistor 330 is turned off, and the bias circuit 20 will not be interfered by the start-up circuit 36. In this manner, a function similar to the above embodiments may be achieved. As such, the bias supply may also have other variations. For example, FIG. 6B is a circuit diagram of a bias supply according to a sixth embodiment of the present invention. In FIG. 6B, the operation principle of the bias supply 17, and the bias circuit 20 and the start-up circuit 37 thereof may refer to the above embodiments, and will not be described herein again.

In view of the above, the present invention uses the charge/discharge properties of the charge storage unit and the feedback voltage from the bias circuit for controlling whether the switch outputs the start-up voltage to the bias circuit or not. Therefore, the power consumption of the start-up circuit may be decreased. Furthermore, the embodiments of the present invention at least have the following advantages.

1. When the charge storage unit is in the charging state, the start-up circuit may continue providing the start-up voltage to the bias circuit, so as to ensure the bias circuit to enter the saturation stable state.

2. When the bias circuit enters the saturation stable state, a feedback technology is utilized to change the voltage of the node, such that the start-up circuit stops outputting the start-up voltage to the bias circuit, thereby preventing the start-up circuit to interfere with the normal operation of the bias circuit.

3. When the charge storage unit is charged to the saturation state, the start-up circuit may stop outputting the start-up voltage to the bias circuit, thereby preventing the start-up circuit to interfere with the normal operation of the bias circuit.

4. When the start-up circuit utilizes the charge/discharge properties of the charge storage unit for controlling whether the switch outputs the start-up voltage to the bias circuit or not, and thus the application level of the start-up circuit may not be limited to the range of the voltage Vdd.

5. When the charge storage unit is charged to the saturation state, two ends of the charge storage unit may be regarded as an open circuit, and thus the leakage current may be reduced greatly.

6. The inverter or the buffer may be utilized to provide a stable voltage level, thereby controlling whether the switch outputs a start-up voltage to the bias circuit or not.

7. The transistors are utilized to implement the charge storage unit, thus saving the circuit area and reducing the cost.

8. Three transistors are utilized to achieve the start-up circuit, thereby reducing the cost of the start-up circuit greatly.

It will be apparent to those skilled in the art that various modifications and variations may be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A bias supply, comprising:
a bias circuit, coupled between a first voltage and a second voltage, and outputting a feedback voltage;
a first switch, coupled between the first voltage and a node, and determining whether or not to be turned on according to the feedback voltage;
a charge storage unit, coupled between the node and the second voltage; and
a second switch, determining whether or not to output a start-up voltage to the bias circuit according to a voltage of the node.

2. The bias supply according to claim 1, further comprising:
a buffer, coupled between the node and the second switch, for providing the voltage of the node to the second switch.

3. The bias supply according to claim 1, further comprising:
an inverter, coupled between the node and the second switch, for providing a reverse potential of the node to the second switch.

4. The bias supply according to claim 3, wherein the inverter comprises:
a first transistor, with a first terminal, a second terminal, and a gate terminal respectively coupled to the first voltage, the second switch, and the node; and
a second transistor, with a first terminal, a second terminal, and a gate terminal respectively coupled to the second switch, the second voltage, and the node.

5. The bias supply according to claim 4, wherein the first transistor is a P-channel metal oxide semiconductor (MOS) transistor, and the second transistor is an N-channel metal oxide semiconductor (MOS) transistor.

6. The bias supply according to claim 1, wherein the bias circuit comprises:
a first current mirror, coupled to the first voltage, and comprising:
a first transistor, with a first terminal coupled to the first voltage, a second terminal, and a gate terminal coupled to the second terminal; and
a second transistor, with a first terminal and a gate terminal respectively coupled to the first terminal and the gate terminal of the first transistor;
a second current mirror, coupled between the first current mirror and the second voltage, and comprising:
a third transistor, with a first terminal and a second terminal respectively coupled to the second terminal of the first transistor and the second voltage; and
a fourth transistor, with a first terminal and a gate terminal coupled to the second terminal of the second transistor, and a second terminal coupled to the second voltage, wherein channel width/length ratios of the third transistor and the fourth transistor are different,
wherein the bias circuit is used to provide a stable bias.

7. The bias supply according to claim 6, wherein when the first terminal of the third transistor receives the start-up voltage, the bias circuit transits from a zero stable state to a saturation stable state, and provides the stable bias.

8. The bias supply according to claim 7, wherein the start-up voltage is the second voltage.

9. The bias supply according to claim 6, wherein when the first terminal of the fourth transistor receives the start-up voltage, the bias circuit transits from the zero stable state to the saturation stable state, and provides the stable bias.

10. The bias supply according to claim 9, wherein the start-up voltage is the first voltage.

11. The bias supply according to claim 6, wherein the feedback voltage is provided by the first terminal of the third transistor or the first terminal of the fourth transistor.

12. The bias supply according to claim 6, wherein the first and second transistors are P-channel MOS transistors, and the third and fourth transistors are N-channel MOS transistors.

13. The bias supply according to claim 1, wherein the first switch comprises:
a first transistor, with a first terminal and a second terminal respectively coupled to the first voltage and the node, and the gate terminal receiving the feedback voltage so as to determine whether or not to conduct the first terminal and second terminal thereof.

14. The bias supply according to claim 1, wherein the charge storage unit comprises:
a capacitor, coupled between the node and the second voltage, outputting the start-up voltage to the bias circuit when the capacitor is in a charging state, and stopping the outputting the start-up voltage to the bias circuit when the capacitor is in a saturation state.

15. The bias supply according to claim 1, wherein the charge storage unit comprises:
a first transistor, with a first terminal and a second terminal coupled to the second voltage, and the gate terminal-coupled to the node.

16. The bias supply according to claim 1, wherein the second switch comprises:
a first transistor, with a first terminal, a second terminal, and a gate terminal respectively coupled to the bias circuit, a third voltage, and the node, determining whether or not to conduct the first terminal and the second terminal thereof according to the voltage of the node.

17. A start-up circuit for starting up a bias circuit, comprising:
a first switch, with a first terminal -and a second terminal respectively coupled to a first voltage and a node, receiving a feedback voltage of the bias circuit so as to determine whether or not to be turned on;
a charge storage unit, with a first terminal and a second terminal respectively coupled to the node and a second voltage; and
a second switch, determining whether or not to provide a start-up voltage to the bias circuit according to a voltage of the node.

18. The start-up circuit according to claim 17, further comprising:
a buffer, coupled between the node and the second switch, for providing the voltage of the node to the second switch.

19. The start-up circuit according to claim 17, further comprising:
an inverter, coupled between the node and the second switch, for proving a reverse potential of the node to the second switch.

20. The start-up circuit according to -claim 19, wherein the inverter comprises:
a first transistor, with a first terminal, a second terminal, and a gate terminal respectively coupled to the first voltage, the second switch, and the node; and
a second transistor, with a first terminal, a second terminal, and a gate terminal respectively coupled to the second switch, the second voltage, and the node.

21. The start-up circuit according to claim 20, wherein the first transistor is a P-channel metal oxide semiconductor (MOS) transistor, and the second transistor is an N-channel metal oxide semiconductor (MOS) transistor.

22. The start-up circuit according to claim 17, wherein the bias circuit comprises:
a first current mirror, coupled to the first voltage, and comprising:
a first transistor, with a first terminal coupled to the first voltage, a second terminal, and a gate terminal coupled to the second terminal; and
a second transistor, with a first terminal and a gate terminal respectively coupled to the first terminal and the gate terminal of the first transistor;
a second current mirror, coupled between the first current mirror and the second voltage, and comprising:
a third transistor, with a first terminal and a second terminal respectively coupled to the second terminal of the first transistor and the second voltage; and
a fourth transistor, with a first terminal and a gate terminal coupled to the second terminal of the second transistor, and a second terminal coupled to the second voltage, wherein channel width/length ratios of the third transistor and the fourth transistor are different,
wherein the bias circuit is used to provide a stable bias.

23. The start-up circuit according to claim 22, wherein when the first terminal of the third transistor receives the start-up voltage, the bias circuit transits from a zero stable state to a saturation stable state, and provides the stable bias.

24. The start-up circuit according to claim 23, wherein the start-up voltage is the second voltage.

25. The start-up circuit according to claim 22, wherein when the first terminal of the fourth transistor receives the start-up voltage, the bias circuit transits from the zero stable state to the saturation stable state, and provides the stable bias.

26. The start-up circuit according to claim 25, wherein the start-up voltage is the first voltage.

27. The start-up circuit according to claim 22, wherein the feedback voltage is provided by the first terminal of the third transistor or the first terminal of the fourth transistor.

28. The start-up circuit according to claim 22, wherein the first and second transistors are P-channel MOS transistors, and the third and fourth transistors are N-channel MOS transistors.

29. The start-up circuit according to claim 17, wherein the first switch comprises:
a first transistor, with a first terminal and a second terminal respectively coupled to the first voltage and the node, and a gate terminal receiving the feedback voltage so as to determine whether or not to conduct the first terminal and the second terminal thereof.

30. The start-up circuit according to claim 17, wherein the charge storage unit comprises:
a capacitor, coupled between the node and the second voltage, outputting the start-up voltage to the bias circuit when the capacitor is in a charging state, and stopping outputting the start-up voltage to the bias circuit when the capacitor is in a saturation state.

31. The start-up circuit according to claim 17, wherein the charge storage unit comprises:
a first transistor with a first terminal and a second terminal coupled to the second voltage, and a gate terminal coupled to the node.

32. The start-up circuit according to claim 17, wherein the second switch comprises:
a first transistor with a first terminal, a second terminal, and a gate terminal respectively coupled to the bias circuit, a third voltage, and the node, determining whether or not to conduct the first terminal and the second terminal thereof according to the voltage of the node.

33. A start-up method for a bias circuit, comprising:
charging a charge storage unit, thereby changing a voltage of a node;
determining whether or not to output a start-up voltage to the bias circuit according the voltage of the node; and
receiving a feedback voltage, thereby changing the voltage of the node.

34. The start-up method for a bias circuit according to claim 33, wherein when the charge storage unit is in a charging state, the node is at a first potential, so as to turn on a first switch to output the start-up voltage to the bias circuit.

35. The start-up method for a bias circuit according to claim 34, wherein when the charge storage unit is in a saturation state, the node is at a second potential, so as to turn off the first switch to stop outputting the start-up voltage to the bias circuit.

36. The start-up method for a bias circuit according to claim 33, wherein the feedback voltage changes along with the state of the bias circuit.

37. The start-up method for a bias circuit according to claim 36, wherein receiving a feedback voltage so as to change the voltage of the node comprises:
determining whether or not to turn on a second switch according to the feedback voltage.

38. The start-up method for a bias circuit according to claim 37, wherein when the bias circuit transits from a zero stable state to a saturation stable state, the feedback voltage makes the potential of the node to transit, so as to cut off the first voltage.
